(19) United States
(12) Patent Application Publication
(10) Pub. No.: US 2011/0131866 A1
(43) Pub. Date: Jun. 9, 2011

(54) A-RAT-A-CATOR

(76) Inventors: Tony Everett, Madison, TN (US); Anetra Mitchell, Madison, TN (US)

(21) Appl. No.: 12/592,783

(22) Filed: Dec. 3, 2009

(51) Int. Cl. A01M 23/36; A01M 23/00

(52) U.S. Cl. 43/77; 43/79

(57) ABSTRACT

The A-RAT-A-CATOR is detours wild animals from getting in to areas not desired. Keep people safe from injury or death from large animals. When any rodents or large animals come in contact with my trap, if trap is placed properly these animals will leave the area. When these animals step on my trap getting a slit injury they will leave and not come back. This includes skunks, opossums, bears, tigers, snakes, large rats and any other rodents that come in contact with this trap if used properly. Put this around garbage cans to keep it safe from being turned over. Put under craw space of you house so animals can't enter. When going camping put the A-RAT-A-CATOR around tents so that snakes and other large animals can't enter the tent. Put this product around log cabins and commercial properties so bears want enter areas not needed.

### BACK GROUND AND SUMMARY OF THE A-RAT-A-CATOR

This product is made out of a hard plastic platform top and bottom. Springs, tack, nuts bolts, washers, and several other ingredients makes up the A-RAT-A-CATOR.

When animals step on the platform the springs lower, razors come up causing slit injury. When animals step off the platform the razors disappear into the platform.

### BRIEF DESCRIPTION OF THE DRAWINGS

FIG. 1. (Top view) of the A-RAT-A-CATOR with a camouflage cover

FIG. 2. The complete package of spike razor, washers, light & heavy springs, 3″ inch & 6″ inch screws, tacks, camouflage covering, bolts and 24″ inch×24″ inch or 36″ inch×36″ inch hard plastic surface makes the A-RAT-A-CATOR.

FIG. 3. (Up view) spikes are invisible on the A-RAT-A-CATOR. (Before animal steps on top)

FIG. 4. (Down view) spikes are visible on the A-RAT-A-CATOR. (After animal steps on top)

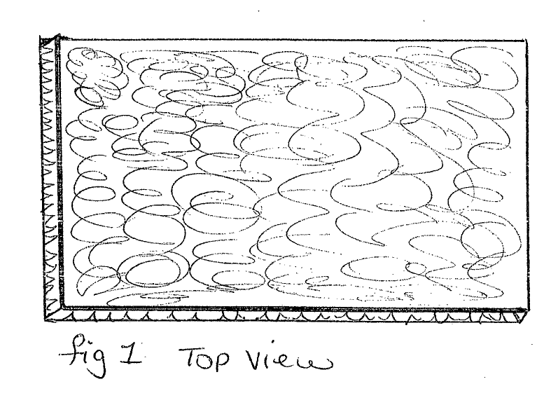

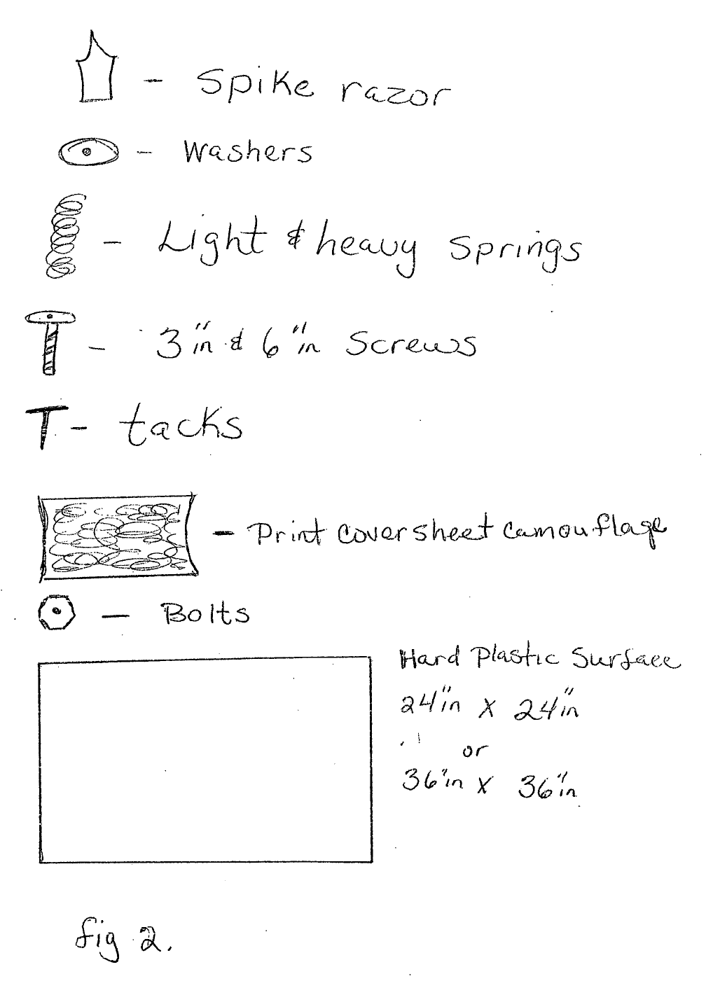

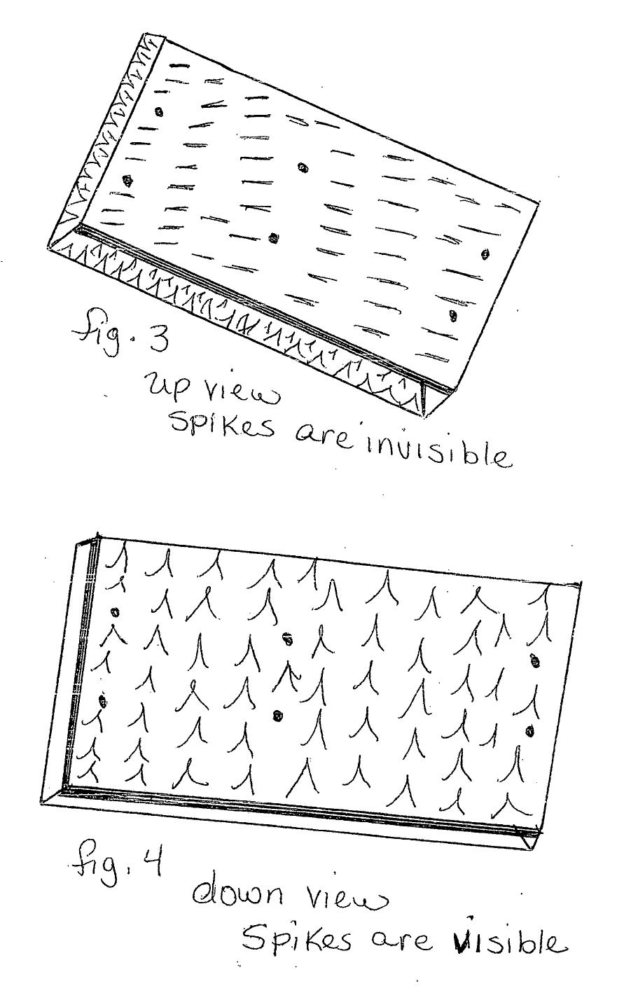

I claim:

1. A-RAT-A-CATOR, comprising of arrow head razors and tacks with large platform varies in size. With light and heavy duty springs, depending on area and what type of animal you want to get rid of. Will keep animals away only with slit injury. Animals want have to be killed or put to sleep if placed properly. If animals do return they will leave again quickly to avoid the A-RAT-A-CATOR.
